(19) United States
(12) Patent Application Publication
(10) Pub. No.: US 2022/0106220 A1
(43) Pub. Date: Apr. 7, 2022

(54) MANUFACTURING METHOD FOR POROUS GLASS DEPOSIT AND APPARATUS FOR MANUFACTURING POROUS GLASS DEPOSIT

(71) Applicant: Shin-Etsu Chemical Co., Ltd., Tokyo (JP)

(72) Inventor: Ryo KAWAMOTO, Ibaraki (JP)

(21) Appl. No.: 17/488,360

(22) Filed: Sep. 29, 2021

(30) Foreign Application Priority Data
Oct. 7, 2020 (JP) 2020-169552

(51) Int. Cl. C03B 37/014; C03B 37/018

(52) U.S. Cl. CPC C03B 37/01406; C03B 37/0144; C03B 37/018

(57) ABSTRACT

Provided is a manufacturing method for a porous glass deposit, comprising by depositing glass fine particle onto a starting material being pulled up in a rotating manner within a reaction chamber using a plurality of burners by which glass fine particles are deposited at positions that are different from each other, supplying humidified clean air to the reaction chamber through an air inlet provided on a wall surface of the reaction chamber in a manufacturing process of the porous glass deposit.

### CROSS REFERENCE TO RELATED APPLICATION

The contents of the following Japanese patent application(s) are incorporated herein by reference:
NO. 2020-169552 filed in JP on Oct. 7, 2020

### BACKGROUND

### 1. Technical Field

The present invention relates to a manufacturing method for a porous glass deposit and an apparatus for manufacturing a porous glass deposit.

### 2. Related Art

Patent document 1 describes that “in an apparatus for manufacturing a porous glass base material, clean air having passed a filter is supplied to an air distribution container, and the clean air is supplied from a plurality of discharge ports of said air distribution container to the reaction chamber through a plurality of air inlets provided on a wall surface of a reaction chamber” (paragraph 0008).

### PRIOR ART DOCUMENT

### Patent Document

Patent document 1: Japanese Patent Application Publication No. 2008-127260

### BRIEF DESCRIPTION OF THE DRAWINGS

FIG. 1 is a schematic diagram describing the outline of a manufacturing apparatus used in the example of the present invention.

### DESCRIPTION OF EXEMPLARY EMBODIMENTS

Hereinafter, the present invention will be described through embodiments of the invention, but the following embodiments do not limit the claimed invention. In addition, not all combinations of features described in the embodiments are essential to the solution of the invention.

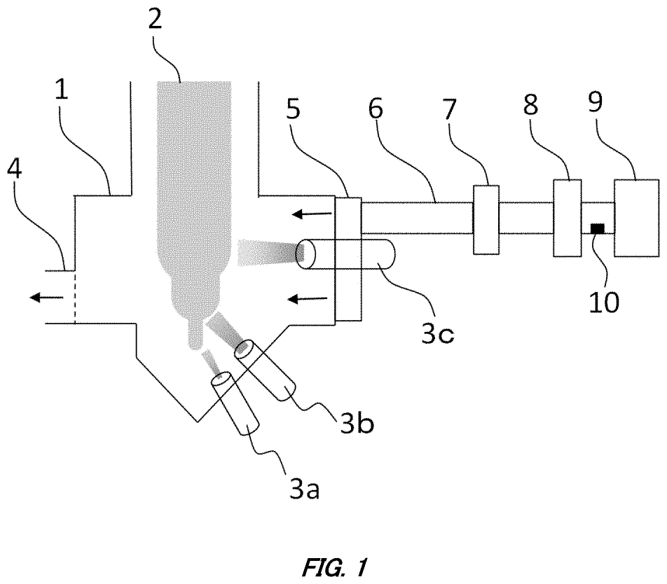

FIG. 1 is a schematic diagram describing the outline of an apparatus for manufacturing a porous glass deposit 2 used in the example of the present invention. The apparatus comprises a reaction chamber 1 having arranged therein a starting material, a core portion deposition burner 3a, an intermediate clad deposition burner 3b, and an outermost clad deposition burner 3c each configured to deposit, from a position that is different from each other, glass fine particles onto a starting material being pulled up in a rotating manner within the reaction chamber 1.

The wall surface of the reaction chamber 1 includes a first wall surface along a direction in which the starting material is pulled up, and a second wall surface which is tilted relative to the first wall surface. Among the wall surfaces of the reaction chamber 1, the outermost clad deposition burner 3c having the highest supply amount of raw material of the core portion deposition burner 3a, the intermediate clad deposition burner 3b, and the outermost clad deposition burner 3c is installed on the first wall surface, and the rest of the burners are installed on the second wall surface. As illustrated in FIG. 1, the core portion deposition burner 3a and the intermediate clad deposition burner 3b are adjacent to each other, whereas the intermediate clad deposition burner 3b and the outermost clad deposition burner 3c are adjacent to each other.

In addition, an air outlet 4 and a plurality of air inlets are provided in the reaction chamber 1. The air outlet 4 is provided on a wall facing the above-mentioned core portion deposition burner 3a or the like, that is, facing the first wall surface and the second wall surface. The plurality of air inlets are provided on the first wall surface. More specifically, the plurality of air inlets are respectively provided above and on both sides of where the outermost clad deposition burner 3c is installed on the first wall surface.

The apparatus further comprises an air distribution container 5 attached to the reaction chamber 1. The air distribution container 5 has a plurality of discharge ports having the same shape as the plurality of air inlets of the reaction chamber 1, and the interior space thereof communicates with the reaction chamber 1 via the plurality of air inlets of the reaction chamber 1 and said plurality of discharge ports.

The apparatus further comprises a duct 6 attached to the air distribution container 5, a filter 7 attached to the duct 6, a blower 8 attached to the filter 7, a humidifier 9 attached to the blower 8, and a temperature and humidity sensor 10 arranged between the blower 8 and the humidifier 9. The blower 8 takes in indoor air and supplies it to the reaction chamber 1 via the air distribution container 5. The humidifier 9 adjusts the humidity of said indoor air taken in by the blower 8, and humidifies said indoor air, for example.

The temperature and humidity sensor 10 monitors the temperature and humidity of the air supplied by the blower 8 to the reaction chamber 1. The filter 7 cleans the air supplied by the blower 8 to the reaction chamber 1 via the duct 6 and the air distribution container 5.

With the above configuration, the air distribution container 5 supplies, to the reaction chamber 1, the clean air for which the humidity is adjusted and cleaned, which is supplied by the blower 8 via the filter 7 and the duct 6. In addition, it can be said that the blower 8 supplies the clean air to the reaction chamber 1 via the air distribution container 5. In addition, it can be said that the humidifier 9 humidifies the clean air supplied by the blower 8 to the reaction chamber 1. In addition, it can be said that the temperature and humidity sensor monitors the temperature and humidity of the clean air supplied by the blower 8 to the reaction chamber 1.

Here, VAD method is known as a manufacturing method of a porous glass deposit for optical fibers. In this method, a starting material is attached to a shaft being lifted in a rotating manner, which is hung within the reaction chamber, and glass fine particles generated by a core deposition burner and a clad deposition burner installed in the reaction chamber are deposited onto the starting material, thereby manufacturing a porous glass deposit formed of a core layer and a clad layer.

Since the deposition efficiency of the generated glass fine particle does not become 100%, the unadhered excess glass fine particles that were not deposited develop through the manufacturing. The majority of these excess glass fine particles is discharged outside the reaction chamber through the air outlet with other gas such as exhaust gas.

However, a part of the excess glass fine particles adhere to the ceiling and the side walls of the reaction chamber during the time between generation thereof by the burners and the discharge thereof. There have been cases where the glass fine particles that adhered to the inner wall of the reaction chamber peeling off and falling to scatter within the reaction chamber and adhere to the porous glass deposit being manufactured, causing generation of air bubbles and foreign substances at the time of creating transparent glass.

In response, in order to improve the discharge efficiency of the glass fine particles that was not deposited, a technology is contemplated for supplying clean air from a plurality of discharge ports of the air distribution container through a plurality of air inlets provided on the wall surface of the reaction chamber to the reaction chamber. However, since the raw material input amount has increased and the absolute amount of excess glass fine particles has increased with the increase in the size of the porous glass deposit for optical fibers, even when the above-mentioned technology is employed, there were peeling off and falling of excess glass fine particle that adhered to the inner wall of the reaction chamber, and moreover, development of air bubbles and foreign substances were found on the base material obtained by creating transparent glass from the porous glass deposit.

Therefore, the manufacturing method of the porous glass deposit 2 according to the present embodiment aims at providing a manufacturing method of the porous glass deposit 2 in which air bubbles are unlikely to be developed after creation of transparent glass, when manufacturing the porous glass deposit 2 for optical fibers using the VAD method. The manufacturing method of the porous glass deposit 2 according to the present embodiment includes manufacturing the porous glass deposit 2 by depositing glass fine particles onto the starting material being pulled up in a rotating manner within the reaction chamber 1 using the core portion deposition burner 3a or the like by which glass fine particles are deposited at positions that are different from each other. The manufacturing method of the porous glass deposit 2 according to the present embodiment comprises supplying humidified clean air to the reaction chamber 1 through an air inlet provided on a wall surface of the reaction chamber 1 in said manufacturing process.

As an example, said supplying step includes keeping an absolute humidity of the clean air at 7 g/m³ or higher and 13 g/m³ or lower. Also, in addition or instead, as an example, said supplying step includes supplying the clean air to the reaction chamber 1 through the air inlet provided on the first wall surface of the reaction chamber 1.

With the manufacturing method of the porous glass deposit 2 according to the present embodiment, the above-mentioned problem can be solved. With manufacturing method of the porous glass deposit 2 according to the present embodiment, peeling off and falling of excess glass fine particles that adhered to the inner wall of the reaction chamber 1 can be prevented during the manufacturing of the porous glass deposit 2, thereby enabling manufacturing of the porous glass deposit 2 where air bubbles are unlikely to be developed when creating transparent glass from said porous glass deposit 2.

Note that, in the above-mentioned supplying step, an air flow rate of the clean air supplied to the reaction chamber 1 is preferably 1 m³/min or higher and 3 m³/min or lower. In addition, the above-mentioned supplying step preferably includes supplying raw material gas to the reaction chamber 1 with a total supply amount of the raw material gas converted in a normal state being 9 kL or more and 15 kL or less per one porous glass deposit 2.

Next, the manufacturing method of the porous glass deposit 2 according to the present embodiment will be described in further details with examples and comparative examples.

### Example 1

500 mL/min of silicon tetrachloride and 20 mL/min of germanium tetrachloride was supplied to the core portion deposition burner 3a as raw material gas. 0.8 L/min and 4.5 L/min of silicon tetrachloride was respectively supplied, as raw material gas, to the intermediate clad deposition burner 3b and the outermost clad deposition burner 3c which are adjacent to each other. In addition, 2 m³/min of clean air was supplied from the air distribution container 5 to the reaction chamber 1 via the air inlet provided on a wall surface of the reaction chamber 1 on which the outermost clad deposition burner 3c is installed.

Ten porous glass deposits 2 were manufactured by depositing glass fine particles at the above-mentioned gas condition. During deposition of the glass fine particles, the absolute humidity of 2 m³/min of the clean air supplied from the air inlet provided on the first wall surface of the reaction chamber 1 was kept at 7 g/m³ or higher and 13 g/m³ or lower by running the humidifier 9 illustrated in FIG. 1.

As a result, excess glass fine particles that adhered to the inner wall of the reaction chamber 1 during the manufacturing did not peel off or fall from the inner wall of the reaction chamber 1.

### Example 2

Raw material gas was supplied to the core portion deposition burner 3a, the intermediate clad deposition burner 3b, and the outermost clad deposition burner 3c under the condition described in example 1. In addition, 1 m³/min of clean air was supplied from the air distribution container 5 to the reaction chamber 1 via the air inlet provided on the first wall surface of the reaction chamber 1.

By depositing glass fine particles under the above-mentioned gas condition, ten porous glass deposits 2 were manufactured. During deposition of the glass fine particles, the absolute humidity of 1 m³/min of the clean air supplied from the air inlet provided on the first wall surface of the reaction chamber 1 was kept at 7 g/m³ or higher and 13 g/m³ or lower by running the humidifier 9 illustrated in FIG. 1.

As a result, the peeling off and falling from the inner wall of the reaction chamber 1 of excess glass fine particles that adhered to the inner wall of the reaction chamber 1 during the manufacturing occurred at a constant frequency of approximately twice within ten cycles of the manufacturing process of the porous glass deposit 2.

### Example 3

Raw material gas was supplied to the core portion deposition burner 3a, the intermediate clad deposition burner 3b, and the outermost clad deposition burner 3c under the condition described in example 1. In addition, 3 m³/min of clean air was supplied from the air distribution container 5 to the reaction chamber 1 via the air inlet provided on the first wall surface of the reaction chamber 1.

Ten porous glass deposits 2 were manufactured by depositing glass fine particles at the above-mentioned gas condition. During deposition of the glass fine particles, the absolute humidity of 3 m³/min of the clean air supplied from the air inlet provided on the first wall surface of the reaction chamber 1 was kept at 7 g/m³ or higher and 13 g/m³ or lower by running the humidifier 9 illustrated in FIG. 1.

As a result, the peeling off and falling from the inner wall of the reaction chamber 1 of excess glass fine particles that adhered to the inner wall of the reaction chamber 1 during the manufacturing occurred at a constant frequency of approximately once within ten cycles of the manufacturing process of the porous glass deposit 2.

### Comparative Example 1

Glass fine particles were deposited under the gas condition described in example 1, without the humidifier 9 running.

In this case, the absolute humidity of 2 m³/min of clean air supplied from the air distribution container 5 to the reaction chamber 1 via the air inlet provided on the first wall surface of the reaction chamber 1 was 6 g/m³ or lower, which is below 7 g/m³. Similarly to the examples, ten porous glass deposits 2 were manufactured.

As a result, the peeling off and falling from the inner wall of the reaction chamber 1 of excess glass fine particles that adhered to the inner wall of the reaction chamber 1 during the manufacturing occurred at a frequency of approximately six times within ten cycles of the manufacturing process of the porous glass deposit 2, which is a higher frequency than the present examples.

The results of the present examples and the comparative example is shown below in Table 1.

| | | | | | | | COMPARATIVE | |
|---|---|---|---|---|---|---|---|---|
| | EXAMPLE 1 | | EXAMPLE 2 | | EXAMPLE 3 | | EXAMPLE | |
| HUMIDIFIER RUNNING | YES | | YES | | YES | | NONE | |
| SUPPLY RATE OF CLEAN AIR | 2 | m3/h | 1 | m³/h | 3 | m³/h | 2 | m³/h |
| TO REACTION CHAMBER | | | | | | | | |
| CLEAN AIR HUMIDITY | 7-13 | g/m³ | 7-13 | g/m³ | 7-13 | g/m³ | 2-6 | g/m³ |
| NUMBER OF MANUFACTURED | TEN | | TEN | | TEN | | TEN | |
| POROUS GLASS DEPOSITS | | | | | | | | |
| PEELING OFF AND FALLING OF | NONE | | TWICE | | ONCE | | SIX TIMES | |
| SOOT FROM REACTION | | | | | | | | |
| CHAMBER INNER WALL | | | | | | | | |
| SUPPLY AMOUNT OF SILICON | 9-15 | kL | 9-15 | kL | 9-15 | kL | 9-15 | kL |
| TETRACHLORIDE PER ONE | | | | | | | | |
| POROUS GLASS DEPOSIT | | | | | | | | |

From the above results, it was found that peeling off and falling from the inner wall of the reaction chamber 1 of excess glass fine particles that adhered to the inner wall of the reaction chamber 1 can be very effectively suppressed by any of the present examples.

The amount of adherence of glass fine particles to the ceiling or the upper portion of the side walls of the reaction chamber 1 increases when the air flow rate of clean air supplied to the reaction chamber 1 from the air inlet provided on the wall surface of the reaction chamber 1 is too low, for example, lower than 1 m³/min. The amount of adherence of glass fine particles near the lower side wall of the reaction chamber 1 increases when said air flow rate is too high, for example, higher than 3 m³/min. Therefore, said air flow rate is preferably 1 m³/min or higher and 3 m³/min or lower, and more preferably, 1.6 m³/min or higher and 2.4 m³/min or lower.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

1: reaction chamber,
2: porous glass deposit,
3a: core portion deposition burner,
3b: intermediate clad deposition burner,
3c: outermost clad deposition burner,
4: air outlet,
5: air distribution container,
6; duct,
7: filter,
8: blower,
9: humidifier,
10: temperature and humidity sensor

What is claimed is:

1. A manufacturing method for a porous glass deposit, comprising:
by depositing glass fine particle onto a starting material being pulled up in a rotating manner within a reaction chamber using a plurality of burners by which glass fine particles are deposited at positions that are different from each other, supplying humidified clean air to the reaction chamber through an air inlet provided on a wall surface of the reaction chamber in a manufacturing process of the porous glass deposit.

2. The manufacturing method according to claim 1, wherein the supplying step includes keeping an absolute humidity of the clean air at 7 g/m³ or higher and 13 g/m³ or lower.

3. The manufacturing method according to claim 1, wherein
the wall surface of the reaction chamber includes a first wall surface along a direction in which the starting material is pulled up and a second wall surface which is tilted relative to the first wall surface,
a burner having the highest supply amount of raw material among the plurality of burners is installed on the first wall surface, and rest of the burners are installed on the second wall surface, and
the supplying step includes supplying the clean air to the reaction chamber through the air inlet provided on the first wall surface of the reaction chamber.

4. The manufacturing method according to claim 2, wherein
the wall surface of the reaction chamber includes a first wall surface along a direction in which the starting material is pulled up and a second wall surface which is tilted relative to the first wall surface,
a burner having the highest supply amount of raw material among the plurality of burners is installed on the first wall surface, and rest of the burners are installed on the second wall surface, and
the supplying step includes supplying the clean air to the reaction chamber through the air inlet provided on the first wall surface of the reaction chamber.

5. The manufacturing method according to claim 1, wherein in the supplying step, an air flow rate of the clean air supplied to the reaction chamber is 1 m³/min or higher and 3 m³/min or lower.

6. The manufacturing method according to claim 2, wherein in the supplying step, an air flow rate of the clean air supplied to the reaction chamber is 1 m³/min or higher and 3 m³/min or lower.

7. The manufacturing method according to claim 3, wherein in the supplying step, an air flow rate of the clean air supplied to the reaction chamber is 1 m³/min or higher and 3 m³/min or lower.

8. The manufacturing method according to claim 4, wherein in the supplying step, an air flow rate of the clean air supplied to the reaction chamber is 1 m³/min or higher and 3 m³/min or lower.

9. The manufacturing method according to claim 1, wherein the supplying step includes supplying raw material gas to the reaction chamber with a total supply amount of the raw material gas converted in a normal state being 9 kL or more and 15 kL or less per one porous glass deposit.

10. The manufacturing method according to claim 2, wherein the supplying step includes supplying raw material gas to the reaction chamber with a total supply amount of the raw material gas converted in a normal state being 9 kL or more and 15 kL or less per one porous glass deposit.

11. The manufacturing method according to claim 3, wherein the supplying step includes supplying raw material gas to the reaction chamber with a total supply amount of the raw material gas converted in a normal state being 9 kL or more and 15 kL or less per one porous glass deposit.

12. The manufacturing method according to claim 4, wherein the supplying step includes supplying raw material gas to the reaction chamber with a total supply amount of the raw material gas converted in a normal state being 9 kL or more and 15 kL or less per one porous glass deposit.

13. The manufacturing method according to claim 5, wherein the supplying step includes supplying raw material gas to the reaction chamber with a total supply amount of the raw material gas converted in a normal state being 9 kL or more and 15 kL or less per one porous glass deposit.

14. The manufacturing method according to claim 6, wherein the supplying step includes supplying raw material gas to the reaction chamber with a total supply amount of the raw material gas converted in a normal state being 9 kL or more and 15 kL or less per one porous glass deposit.

15. The manufacturing method according to claim 7, wherein the supplying step includes supplying raw material gas to the reaction chamber with a total supply amount of the raw material gas converted in a normal state being 9 kL or more and 15 kL or less per one porous glass deposit.

16. The manufacturing method according to claim 8, wherein the supplying step includes supplying raw material gas to the reaction chamber with a total supply amount of the raw material gas converted in a normal state being 9 kL or more and 15 kL or less per one porous glass deposit.

17. An apparatus for manufacturing a porous glass deposit, wherein
by depositing glass fine particle onto a starting material being pulled up in a rotating manner within a reaction chamber using a plurality of burners by which glass fine particles are deposited at positions that are different from each other, humidified clean air is supplied to the reaction chamber through an air inlet provided on a wall surface of the reaction chamber in a manufacturing process of the porous glass deposit.

18. An apparatus for manufacturing a porous glass deposit, comprising:
a reaction chamber having arranged therein a starting material, and provided thereon an air outlet and a plurality of air inlets;
a plurality of burners each configured to deposit, from a position that is different from each other, glass fine particles toward the starting material being pulled up in a rotating manner within the reaction chamber;
an air distribution container attached to the reaction chamber and having a plurality of discharge ports having the same shape as the plurality of air inlets of the reaction chamber, wherein an interior space thereof communicates with the reaction chamber through the plurality of discharge ports and the plurality of air inlets;
a blower configured to supply clean air to the reaction chamber via the air distribution container; and
a humidifier configured to humidify the clean air supplied to the reaction chamber by the blower.

19. The apparatus according to claim 18, wherein the humidifier is configured to keep an absolute humidity of the clean air at 7 g/m³ or higher and 13 g/m³ or lower.

20. The apparatus according to claim 18, further comprising a temperature and humidity sensor configured to monitor a temperature and humidity of the clean air supplied to the reaction chamber by the blower.
